(19) United States
(12) Patent Application Publication
(10) Pub. No.: US 2026/0267130 A1
(43) Pub. Date: Sep. 10, 2026

(54) SIGHT DEVICE

(71) Applicant: Asia Optical Co., Inc., Taichung (TW)

(72) Inventor: Shang-Yung Liang, Taichung (TW)

(21) Appl. No.: 19/556,021

(22) Filed: Mar. 4, 2026

(30) Foreign Application Priority Data
Mar. 7, 2025 (TW) 114108538

(51) Int. Cl. G02B 23/00; F41G 1/38; G02B 27/32

(52) U.S. Cl. CPC G02B 23/00; G02B 27/32; F41G 1/38

(57) ABSTRACT

A sight device includes a main lens barrel, an erector lens barrel, an objective lens unit and an erector unit. The erector lens barrel is disposed in the main lens barrel and includes a first end portion and a second end portion opposite to the first end portion. The objective lens unit is disposed in the main lens barrel, allowing an inverted real image is formed on a first image plane. The erector unit is disposed in the erector lens barrel, allowing the inverted real image and an image of an aiming reticle structure to form an upright real image on the second image plane. The first end portion and the first image plane are sequentially arranged along a direction from an objective lens end towards an ocular lens end. The second end portion and the second image plane have an interval therebetween.

### BACKGROUND OF THE INVENTION

### Field of the Invention

The invention relates to a technical field of a sight structure, and more particularly to a sight device.

### Description of the Related Art

A sight for weapons or rangefinders is used to aim at a target object to be fired or ranged. A known sight generally has not only an aiming reticle but a transparent display to show information about the target object or equipment, such as distance of the target object, time, or battery level, allowing the user to view related information during aiming operation.

The described sight has the aiming reticle and the transparent display disposed on a first image plane and a second image plane, respectively. In operation, light from the target object passes through an objective lens unit to form an inverted real image on the first image plane. The inverted real image of the target object and the light of the aiming reticle pass through an erector unit to form an upright real image on the second image plane. The upright real image and the light from the transparent display pass through an ocular lens unit to form a magnified virtual image for the user to view.

In the described sight, the erector unit is disposed within an erector lens barrel. The aiming reticle and the transparent display are physically mounted at opposite ends of the erector lens barrel. The aiming reticle is fixed at an end of the erector lens barrel by engagement. Multiple setting bolts are radially propped against the transparent display to adjust the radial position of the transparent display. Also, different numbers of washers are provided to adjust the axial position of the transparent display. The washers are fixed by a pressure ring from the end edge. This ensures the transparent display is positioned on the second image plane and aligned with the aiming reticle.

For an erector unit with a longer focal length, the image distance will increase when the object distance is the same (the lens formula 1/p+1/q=1/f where p is the object distance, q is the image distance, and f is the focal length). Accordingly, the second image plane will be located on the outer side from the edge of the erector lens barrel. If the washers and pressure rings are used to adjust the axial position of the transparent display, the erector lens barrel must be elongated towards the ocular lens unit so that the end edge of the erector lens barrel is located beyond the second image plane. This may cause interference of the erector lens barrel with the ocular lens unit. Therefore, alternative solutions are required that are able to adjust the axial position of the transparent display without elongating the erector lens barrel.

### BRIEF SUMMARY OF THE INVENTION

An object of the invention is to provide a sight device, in which the axial position of the transparent display can be adjusted even if the second image plane is located outside the erector lens barrel.

The sight device in accordance with an exemplary embodiment of the invention includes a main lens barrel, an erector lens barrel, an objective lens unit and an erector unit. The main lens barrel includes an objective lens end and an ocular lens end, wherein the optical axis is extended in an axial direction of the main lens barrel and passes through the main lens barrel. The erector lens barrel includes a first end portion and a second end portion disposed opposite to the first end portion, wherein the erector lens barrel is disposed in the main lens barrel and the optical axis extended in the axial direction of the main lens barrel is configured to pass through the first end portion and the second end portion. The objective lens unit is disposed in the main lens barrel and disposed at the objective lens end, wherein the optical axis is extended to pass through the objective lens unit and the objective lens unit has a first image plane disposed at the first end portion. The erector unit is disposed in the main lens barrel, wherein the optical axis is extended to pass through the erector unit and the erector unit has a second image plane. The second end portion includes a second end surface disposed towards the ocular lens end. The second end surface and the second image plane are sequentially arranged along the optical axis from the objective lens end to the ocular lens end. The second end surface and the second image plane have an interval therebetween.

In another exemplary embodiment, the sight device further includes a display module disposed at the second end portion. The display module includes a display disposed on the second image plane, a support configured to carry the display, and a plurality of positioning adjustment elements. The second end portion defines a plurality of mounting holes. The support is disposed in the second end portion and defines a plurality of adjustment holes corresponding to the mounting holes. Each of the positioning adjustment elements is passed through one mounting hole and the corresponding adjustment hole in a radial direction perpendicular to the optical axis so as to position the support. Each of the adjustment holes is larger than each of the positioning adjustment elements in a direction of the optical axis so that a location of the support can be adjusted by moving the support along the optical axis until the display is located on the second image plane.

In yet another exemplary embodiment, the support is annular. The display module further includes a fixing ring disposed in the second end portion and propped against an internal wall of the support. The fixing ring is an elastic ring with a deformable opening. The support is movable with respect to the fixing ring. The fixing ring defines a plurality of positioning holes corresponding to the mounting holes. The positioning adjustment elements are connected to the positioning holes so that the support is held by an inner wall of the second end portion and an outer wall of the fixing ring.

In another exemplary embodiment, the sight device further includes a display module disposed at the second end portion. The display module includes a display disposed on the second image plane, and a support configured to carry the display. The second end portion further includes a curved flange. The first end portion includes a first end surface. The sight device satisfies any of the following conditions 0 mm 21 d≤16.5 mm, 0<d/(R1×2)≤0.55, 0<(L2−L1)/d≤0.45, and 0.9≤|d−L3|/R1≤0.17, where d is a dimension of the interval, R1 is a radius of the curved flange, L1 is a distance between the first image plane and the second image plane, L2 is a distance between the first end surface and the second end surface, and L3 is a dimension measured along the optical axis.

In yet another exemplary embodiment, the positioning holes are circumferentially formed on the fixing ring at equal angular intervals. The mounting holes are circumferentially formed on the second end portion at equal angular intervals. The adjustment holes are circumferentially formed on the support at equal angular intervals.

In another exemplary embodiment, the positioning holes are threaded holes. The mounting holes are through holes. The adjustment holes are elongated slots. The positioning adjustment elements are bolts.

In yet another exemplary embodiment, the mounting holes are threaded holes. The adjustment holes are elongated blind holes. The positioning adjustment elements are bolts.

In another exemplary embodiment, the sight device further includes an ocular lens unit and an aiming reticle element. The ocular lens unit is disposed at the ocular lens end of the main lens barrel. The aiming reticle element is disposed in the first end portion and propped against an inner surface of a main body of the sight device. The ocular lens unit has a third focal length. A distance between an upright real image formed on the second image plane and the ocular lens unit is less than the third focal length. The aiming reticle element includes an aiming reticle structure disposed on the first image plane. The optical axis is configured to pass through the aiming reticle element.

In yet another exemplary embodiment, the sight device further includes a display module including a display and a support. The support includes an internal wall which defines an annular mounting groove. The display includes an annular bracket and a display panel disposed on the annular bracket. The annular bracket engages with the annular mounting groove, so as to position the display panel on the support.

In another exemplary embodiment, the sight device includes a main lens barrel, an erector lens barrel, an objective lens unit and an erector unit. The sight device has an optical axis. The main lens barrel includes an objective lens end and an ocular lens end, wherein the optical axis is extended in an axial direction of the main lens barrel and passes through the main lens barrel. The erector lens barrel includes a first end portion and a second end portion disposed opposite to the first end portion, wherein the erector lens barrel is disposed in the main lens barrel, the first end portion includes a first end surface, the second end portion includes a second end surface, and the optical axis extended in the axial direction of the main lens barrel is configured to sequentially pass through the first end surface, the first end portion, the second end portion, and the second end surface. The objective lens unit is disposed in the main lens barrel and disposed at the objective lens end, wherein the optical axis is extended to pass through the objective lens unit and the objective lens unit has a first image plane disposed at the first end portion. The erector unit is disposed in the main lens barrel, wherein the optical axis is extended to pass through the erector unit and the erector unit has a second image plane. The first end surface has a first distance from the second end surface measured along the optical axis. The first end surface has a second distance from the second image plane measured along the optical axis. The first distance is less than the second distance and the first distance and the second distance have an interval therebetween.

In yet another exemplary embodiment, the sight device further includes a display module disposed at the second end portion. The display module includes a display disposed on the second image plane, a support configured to carry the display, and a plurality of positioning adjustment elements. The second end portion defines a plurality of mounting holes. The support is disposed in the second end portion and defines a plurality of adjustment holes corresponding to the mounting holes. Each of the positioning adjustment elements is passed through one mounting hole and the corresponding adjustment hole in a radial direction perpendicular to the optical axis so as to position the support. Each of the adjustment holes is larger than each of the positioning adjustment elements in a direction of the optical axis so that a location of the support can be adjusted by moving the support along the optical axis until the display is located on the second image plane.

In another exemplary embodiment, the support is annular. The display module further includes a fixing ring disposed in the second end portion and propped against an internal wall of the support. The fixing ring is an elastic ring with a deformable opening. The support is movable with respect to the fixing ring. The fixing ring defines a plurality of positioning holes corresponding to the mounting holes. The positioning adjustment elements are connected to the positioning holes so that the support is held by an inner wall of the second end portion and an outer wall of the fixing ring.

In yet another exemplary embodiment, the sight device further includes a display module disposed at the second end portion. The display module includes a display disposed on the second image plane, and a support configured to carry the display. The second end portion further includes a curved flange. The sight device satisfies any of the following conditions: 0mm<d≤16.5 mm, 0<d/(R1×2)≤0.55, 0<(L2−L1)/d≤0.45, and 0.9≤|d−L3|/R1≤0.17, where d is a dimension of the interval, R1 is a radius of the curved flange, L1 is a distance between the first image plane and the second image plane, L2 is a distance between the first end surface and the second end surface, and L3 is a dimension measured along the optical axis.

In another exemplary embodiment, the positioning holes are circumferentially formed on the fixing ring at equal angular intervals. The mounting holes are circumferentially formed on the second end portion at equal angular intervals. The adjustment holes are circumferentially formed on the support at equal angular intervals.

In yet another exemplary embodiment, the positioning holes are threaded holes. The mounting holes are through holes. The adjustment holes are elongated slots. The positioning adjustment elements are bolts.

In another exemplary embodiment, the mounting holes are threaded holes. The adjustment holes are elongated blind holes. The positioning adjustment elements are bolts.

In yet another exemplary embodiment, each of the adjustment hole is larger than the positioning adjustment element in a circumferential direction of the support, such that the support can be rotated and adjusted in the circumferential direction.

In another exemplary embodiment, the second end portion further includes a curved flange. The mounting holes are formed on the curved flange. The positioning adjustment elements are provided with the same or different radial engagement depth relative to the positioning holes, so that a radial position of the display on the second image plane can be adjusted, thereby calibrating and aligning the display with the upright real image.

In yet another exemplary embodiment, the sight device further includes an ocular lens unit and an aiming reticle element. The ocular lens unit is disposed at the ocular lens end of the main lens barrel. The aiming reticle element is disposed in the first end portion and propped against an inner surface of a main body of the sight device. The ocular lens unit has a third focal length. A distance between an upright real image formed on the second image plane and the ocular lens unit is less than the third focal length. The aiming reticle element includes an aiming reticle structure disposed on the first image plane. The optical axis is configured to pass through the aiming reticle element.

In another exemplary embodiment, the sight device further includes a display module including a display and a support. The support includes an internal wall which defines an annular mounting groove. The display includes an annular bracket and a display panel disposed on the annular bracket. The annular bracket engages with the annular mounting groove, so as to position the display panel on the support.

The erector unit of the sight device of the invention has a second focal length greater than that of the prior art. According to the lens formula 1/f=1/p+1/q, the image distance q will be increased if the object distance (i.e. the distance between the inverted real image and the erector unit) is unchanged and the focal length f is increased. Therefore, in the invention in which the second focal length is increased, the second image plane is located outside the erector lens barrel.

Further, in the sight device of the invention, the erector lens barrel is provided with mounting holes, the support of the display module is provided with adjustment holes, and the fixing ring is provided with fixing holes. Positioning adjustment elements sequentially penetrate through the mounting holes and the adjustment holes to be positioned in the positioning holes. Each of the adjustment holes is larger than each of the positioning adjustment elements in a direction of the optical axis so that a location of the support can be adjusted by moving the support along the optical axis until the display is located on the second image plane. Then, the positioning adjustment elements are fixed to the positioning holes of the fixing ring so that the support is held by an inner wall of the second end portion and an outer wall of the fixing ring. By such arrangement, the display is positioned on the second image plane.

In the sight device of the invention, when the second focal length is increased, the second image plane becomes located outside the erector lens barrel. Further, the sight device of the invention provides mounting holes in the erector lens barrel, adjustment holes in the support of the display module, positioning holes in the fixing ring, and positioning adjustment elements which are sequentially penetrated through the mounting holes and the adjustment holes to be positioned in the positioning hole. Further, the dimension of the adjustment hole measured in the direction of the optical axis is greater than the dimension of each positioning adjustment element measured in the direction of the optical axis. Such arrangement allows the support to move along the direction of the optical axis to adjust the position of the display until the display is located on the second image plane. Then, the positioning adjustment elements are fixed in the positioning holes of the fixing ring, and the support is clamped and positioned by the inner wall of the second end portion and the outer wall of the fixing ring, thereby positioning the display on the second image plane. Even when the second image plane is formed outside the erector lens barrel, the axial position of the display can still be adjusted.

### BRIEF DESCRIPTION OF THE DRAWINGS

FIG. 1 is a schematic view of a sight device in accordance with an embodiment of the invention.

FIG. 2 is a perspective exploded view of an erector lens barrel, an aiming reticle element, a display module and a fixing ring of the sight device of FIG. 1.

FIG. 3 is a sectional view of the erector lens barrel, the aiming reticle element, the display module and the fixing ring of the sight device of FIG. 1.

FIG. 4 is a schematic view showing the positional relationship of the positioning adjustment element and the support of the display module of the sight device of FIG. 1.

FIG. 5 is a schematic view showing that the display module is linearly moved in a direction perpendicular to the optical axis for aligning the display with the aiming reticle structure.

### DETAILED DESCRIPTION OF THE INVENTION

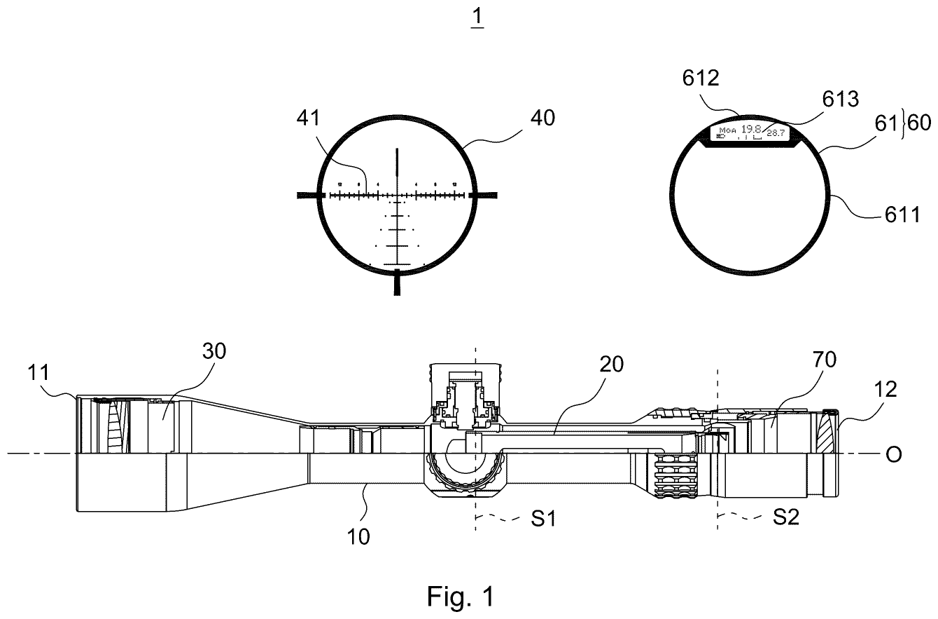

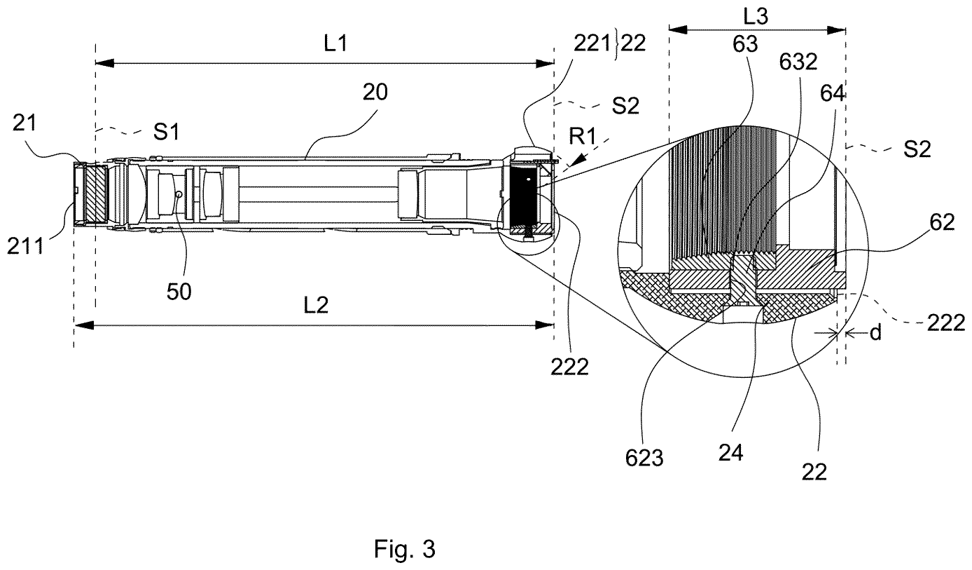

Referring to FIGS. 1-3, a sight device 1 of an embodiment of the invention has an optical axis O. The sight device 1 includes a main lens barrel 10, an erector lens barrel 20, an objective lens unit 30, an aiming reticle element 40, an erector unit 50, a display module 60, and an ocular lens unit 70. The erector lens barrel 20 is disposed in the main lens barrel 10. The central axis of the erector lens barrel 20 and the central axis of the main lens barrel 10 coincide. The optical axis O is extended along the central axes of the main lens barrel 10 and the erector lens barrel 20 to pass through the objective lens unit 30, the aiming reticle element 40, the erector unit 50, and the display module 60.

The main lens barrel 10 has two opposite ends which are an objective lens end 11 and an ocular lens end 12. The diameter of the objective lens end 11 is greater than that of the ocular lens end 12. The objective lens unit 30 is disposed at the objective lens end 11. The ocular lens unit 70 is disposed at the ocular lens end 12.

The erector lens barrel 20 is disposed in the main lens barrel 10 and between the objective lens end 11 and the ocular lens end 12. Specifically, the erector lens barrel 20 is disposed between the objective lens unit 30 and the ocular lens unit 70. The erector lens barrel 20 includes a first end portion 21 and a second end portion 22 disposed opposite to each other. The aiming reticle element 40 is disposed at the first end portion 21. The display module 60 is disposed at the second end portion 22. The erector unit 50 is disposed in the main lens barrel 10 and between the first end portion 21 and the second end portion 22. Specifically, the erector unit 50 is disposed between the aiming reticle element 40 and the display module 60. The first end portion 21 has a first end surface 211 at an end near the objective lens unit 30. The second end portion 22 has a second end surface 222 at an end near the ocular lens unit 70. The second end portion 22 further has a curved flange 221 at the outer circumferential wall thereof.

The aiming reticle element 40 is a transparent lens provided with an aiming reticle structure 41. The aiming reticle structure 41 is, for example, a reticle pattern or a dot pattern.

The display module 60 includes a display 61 and a support 62 for carrying the display 61. In this embodiment, the support 62 is annular. The support 62 has an internal wall on which an annular mounting groove 621 is provided, and a top at which a mounting opening 622 is formed. The display 61 includes an annular bracket 611 and a positioning platform 612 disposed on the annular bracket 611. The annular bracket 611 engages with the annular mounting groove 621. The positioning platform 612 is propped against the edges of the mounting opening 622 so that the display panel 613 is positioned on the support 62. The image light generated by the display panel 613 is projected towards the ocular lens unit 70 in a direction parallel to the optical axis O.

In operation, when a sight device 1 is directed to a target object, light from the target object enters the objective lens unit 30. The objective lens unit 30 has a first focal length f1. The light of the target object passes through the objective lens unit 30 to form an inverted real image on a first image plane S1. According to the lens formula 1/f1=1/p1+1/q1, the value of 1/p1 is very small (close to 0) when the object distance p1 is much greater than the first focal length f1. Therefore, the distance q1 between the inverted real image and the center of the objective lens unit 30 (the distance between the first image plane S1 and the center of the objective lens unit 30) is approximately equal to the first focal length f1. In this embodiment, the first image plane S1 is located at the first end portion 21 of the erector lens barrel 20. The first end portion 21 and the first image plane S1 are sequentially arranged along the optical axis O from the objective lens end 11 towards the ocular lens end 12. The aiming reticle element 40 is disposed at the first end portion 21 and on the first image plane S1.

The inverted real image and light generated from the aiming reticle element 40 pass through the erector unit 50 to form an upright real image on a second image plane S2. The erector unit 50 has a second focal length f2. The distance between the inverted real image (or the aiming reticle element 40) and the center of the erector unit 50 is the object distance p2. According to the lens formula 1/f2=1/p2+1/q2, the image distance q2 between the upright real image and the center of the erector unit 50 will be increased if the object distance p2 is unchanged and the second focal length f2 is increased. Therefore, when the second focal length f2 increases to be greater than a critical value, the image distance q2 will be greater than the distance between the end edge of the second end portion 22 and the center of the erector unit 50. That is, the second image plane S2 is formed on the second end surface 222 near the end edge of the second end portion 22 of the erector lens barrel 20 and is located outside the erector lens barrel 20, and there is an interval d formed between the second end surface 222 of the second end portion 22 and the second image plane S2. Therefore, the distance between the first end surface 211 and the second end surface 222 is less than the distance between the first end surface 211 and the second image plane S2. It is understood that the distance between the first end surface 211 and the second end surface 222 measured in a direction parallel to the optical axis is the maximum distance of the erector lens barrel 20. Because the upright real image and the image shown by the display panel 613 of the display module 60 are simultaneously viewed by the user through the ocular lens unit 70, the display panel 613 must be disposed in an axial position same as the upright real image, namely the display panel 613 must be disposed on the second image plane S2.

The interval d is the distance from the second end face 222 to the ocular lens unit 70 minus the adjustment amount of the ocular lens unit 70 due to the user's vision (myopia or hyperopia). If the user does not need diopter adjustment, the range of the interval d is 0mm<d≤16.5 mm. A preferred range of the interval d is 0.05 mm≤d≤15.5 mm. If the user needs diopter adjustment, the range of the interval d is 0<d≤10 mm. A preferred range of the interval d is 0.05 mm≤d≤9 mm.

In order to accommodate the ballistic compensation adjustments made by the user, a sight device in a preferred embodiment of the invention is configured to satisfy any of the following conditions:

0 mm<d≤16.5 mm (1),

0<d/(R1×2)≤0.55 (2),

0<(L2−L1)/d≤0.45 (3),

0.9≤|d−L3|/R1≤0.17 (4),

where d is the interval, R1 is a radius of a curved flange 221 of the send end portion 22, L1 is a distance from the first image plane S1 to the second image plane, L2 is a distance from the first end surface 211 to the second end surface 222, and L3 is a length of support 62 measured along the optical axis. It is worth noting that the dimension L2 does not include the distance by which the support 62 extends beyond the second end surface 222.

The ocular lens unit 70 has a third focal length f3. Since the upright real image and the image on the display panel 613 need to be magnified for the user to view, the object distance between the upright real image (or the image on the display panel 613) and the center of the ocular lens unit 70 is set to be less than the third focal length f3 of the ocular lens unit 70. According to the lens formula 1/f3=1/p3+1/q3, the image distance q3 will be negative if the object distance p3 is less than the third focal length f3. A negative image distance q3 indicates that a magnified virtual image is obtained on the same side as the upright real image in the ocular lens unit 70 for the user to view.

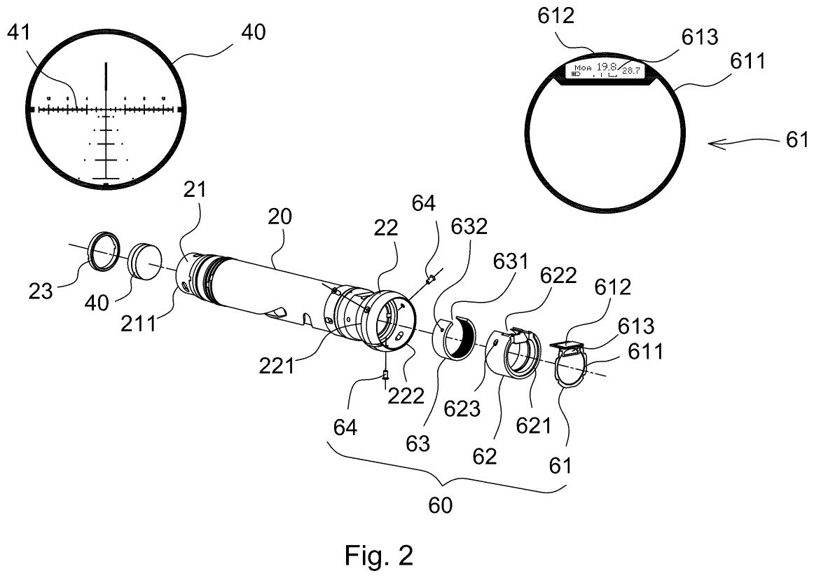

As shown in FIG. 2, the aiming reticle element 40 has an end surface propped against the erector lens barrel 20 to form a necking structure at the first end portion 21, and another end surface pressed by a pressure ring 23 such that the aiming reticle element 40 is limited in position in the direction along the optical axis O and is fixed on the first image plane S1.

The erector lens barrel 20 has a plurality of mounting holes 24 radially penetrating therethrough and circumferentially arranged at the second end portion 22. The mounting holes 24 are formed on the curved flange 221. The support 62 of the display module 60 has a plurality of circumferentially-arranged adjustment holes 623. The display module 60 further includes a fixing ring 63. The fixing ring 63 has a deformable opening 631 on one side and multiple circumferentially-arranged positioning holes 632. By such arrangement, the fixing ring 63, when undergoing elastic deformation due to push forces, will have its diameter reduced. Thus, the fixing ring 63 is positioned on the inner wall of the support 62 and the positioning hole 632 is aligned with the mounting hole 24 of the erector lens barrel 20 and the adjustment hole 623 of the support 62.

The display module 60 further includes multiple positioning adjustment elements 64. Each of the positioning adjustment elements 64 passes sequentially from the outside of the erector lens barrel 20 through the mounting hole 24 and the adjustment hole 623, and connects to the positioning hole 632. In this embodiment, the mounting hole 24 is a through hole, the adjustment hole 623 is a through hole, the positioning hole 632 is a threaded hole 632, and the positioning adjustment element 64 is a setting bolt. In this embodiment, the positioning adjustment element 64 connects to the positioning hole 632, and the positioning adjustment element 64 (i.e. the setting bolt) connects to the fixing ring 63 through threads with the bolt head propped against the second end portion 22. By such arrangement, the support 62 is held by the fixing ring 63 and the second end portion 22 so as to be positioned in the direction of the optical axis O.

The positioning holes 632 are circumferentially formed on the fixing ring 63 at equal angular intervals. The mounting holes 24 are circumferentially formed on the second end portion 22 at equal angular intervals. The adjustment holes 623 are circumferentially formed on the support 62 at equal angular intervals.

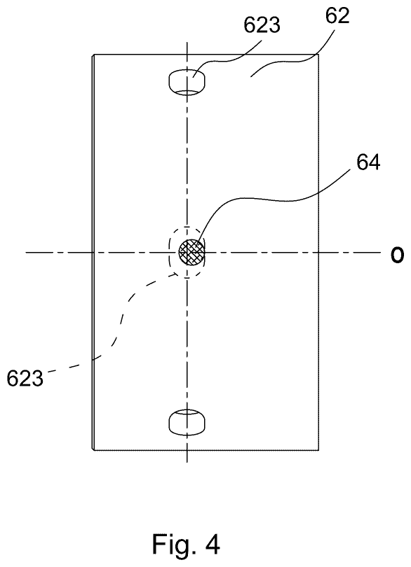

Referring to FIG. 4, the adjustment hole 623 of this embodiment is an elongated slot so that the display 613 of the display module 60 can be located on the second image plane S2 by adjustment. The dimension of the adjustment hole 623 in the direction of the optical axis O is greater than that of the positioning adjustment element 64 in the direction of the optical axis O, namely the distance between the two opposite inner walls of the adjustment hole 623 in the direction of the optical axis O is greater than the diameter of the positioning adjustment element 64. This allows the support 62 to move relative to the fixing ring 63 and the second end 22 to adjust the axial position of the display panel 613. By such arrangement, the axial position of the display panel 613 can be adjusted by moving the support 62 with respect to the fixing ring 63 and the second end portion 22. Further, the dimension of the adjustment hole 623 in the circumferential direction of the support 62 is greater than that of the positioning adjustment element 64 in the circumferential direction of the support 62, so that the angle of the display panel 613 with respect to the optical axis O can be adjusted by rotating the support 62 in the circumferential direction.

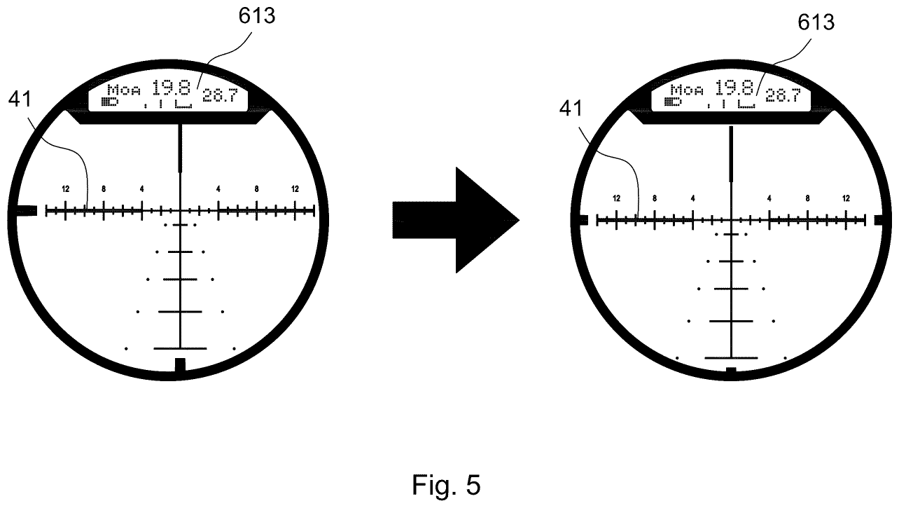

Referring to FIG. 5, if the image shown by the display panel 613 deviates from the aiming reticle structure 41 of the aiming reticle element 40, then the positioning adjustment element 64 can be provided with the same or different radial engagement depth relative to the positioning hole 632, so that the display panel 613 can be moved on the second image plane S2 to adjust the radial position thereof, thereby calibrating and aligning the display panel 613 with the aiming reticle structure 41.

With respect to the support 62 of the display module 60 of this embodiment, because the adjustment hole 623 is larger than the positioning adjustment element 64 in both the direction of the optical axis O and the circumferential direction, the position of the support 62 can be adjusted in both the direction of the optical axis O and the circumferential direction, thereby allowing the position of the display panel 613 to be adjusted in both the direction of the optical axis O and the circumferential direction. Further, the positioning adjustment element 64 is provided with the same or different radial engagement depth relative to the positioning hole 632, whereby the radial position of the support 62 can be adjusted and the radial position of the display panel 613 can be adjusted accordingly. This forms a three-axis fine-tuning structure for the support 62 and the display panel 613.

In some other embodiments, the fixing ring can be omitted, the mounting hole is a threaded hole, and the adjustment hole is an elongated blind hole. Further, the positioning adjustment element is provided with the same or different radial engagement depth relative to the mounting hole, and is propped against the support so as to adjust the radial position of the support. Further, the adjustment hole is larger than the positioning adjustment element in both the direction of the optical axis and the circumferential direction, so as to adjust the positions of the support and the display panel in the direction of the optical axis and the circumferential direction. This also forms a three-axis fine-tuning structure for the support and the display panel.

The erector unit of the sight device of the invention has a second focal length greater than that of the prior art. According to the lens formula 1/f=1/p+1/q, the image distance q will be increased if the object distance (i.e. the distance between the inverted real image and the erector unit) is unchanged and the focal length f is increased. Therefore, in the invention in which the second focal length is increased, the second image plane is located outside the erector lens barrel.

Further, in the sight device of the invention, the erector lens barrel is provided with mounting holes, the support of the display module is provided with adjustment holes, and the fixing ring is provided with fixing holes. Positioning adjustment elements sequentially penetrate through the mounting holes and the adjustment holes to be positioned in the positioning holes. Each of the adjustment holes is larger than each of the positioning adjustment elements in a direction of the optical axis so that a location of the support can be adjusted by moving the support along the optical axis until the display is located on the second image plane. Then, the positioning adjustment elements are fixed to the positioning holes of the fixing ring so that the support is held by an inner wall of the second end portion and an outer wall of the fixing ring. By such arrangement, the display is positioned on the second image plane.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sight device having an optical axis, comprising:
a main lens barrel comprising an objective lens end and an ocular lens end, wherein the optical axis is extended in an axial direction of the main lens barrel and passes through the main lens barrel;
an erector lens barrel comprising a first end portion and a second end portion disposed opposite to the first end portion, wherein the erector lens barrel is disposed in the main lens barrel and the optical axis extended in the axial direction of the main lens barrel is configured to pass through the first end portion and the second end portion;
an objective lens unit disposed in the main lens barrel and disposed at the objective lens end, wherein the optical axis is extended to pass through the objective lens unit and the objective lens unit has a first image plane disposed at the first end portion;
an erector unit disposed in the main lens barrel, wherein the optical axis is extended to pass through the erector unit and the erector unit has a second image plane;
wherein the second end portion comprises a second end surface disposed towards the ocular lens end;
wherein the second end surface and the second image plane are sequentially arranged along the optical axis from the objective lens end to the ocular lens end;
wherein the second end surface and the second image plane have an interval therebetween.

2. The sight device as claimed in claim 1, further comprising:
a display module disposed at the second end portion;
wherein the display module comprises a display disposed on the second image plane, a support configured to carry the display, and a plurality of positioning adjustment elements;
wherein the second end portion defines a plurality of mounting holes;
wherein the support is disposed in the second end portion and defines a plurality of adjustment holes corresponding to the mounting holes;
wherein each of the positioning adjustment elements is passed through one mounting hole and the corresponding adjustment hole in a radial direction perpendicular to the optical axis so as to position the support;
wherein each of the adjustment holes is larger than each of the positioning adjustment elements in a direction of the optical axis so that a location of the support can be adjusted by moving the support along the optical axis until the display is located on the second image plane.

3. The sight device as claimed in claim 2, wherein:
the support is annular;
the display module further comprises a fixing ring disposed in the second end portion and propped against an internal wall of the support;
the fixing ring is an elastic ring with a deformable opening;
the support is movable with respect to the fixing ring;
the fixing ring defines a plurality of positioning holes corresponding to the mounting holes;
the positioning adjustment elements are connected to the positioning holes so that the support is held by an inner wall of the second end portion and an outer wall of the fixing ring.

4. The sight device as claimed in claim 1, further comprising:
a display module disposed at the second end portion;
wherein the display module comprises a display disposed on the second image plane, and a support configured to carry the display;
wherein the second end portion further comprises a curved flange;
wherein the first end portion comprises a first end surface;
wherein the sight device satisfies any of the following conditions:
0 mm<d≤16.5 mm,
0<d/(R1×2)≤0.55,
0<(L2−L1)/d≤0.45,
0.9≤|d−L3|/R1≤0.17,
where d is a dimension of the interval, R1 is a radius of the curved flange, L1 is a distance between the first image plane and the second image plane, L2 is a distance between the first end surface and the second end surface, and L3 is a dimension measured along the optical axis.

5. The sight device as claimed in claim 3, wherein:
the positioning holes are circumferentially formed on the fixing ring at equal angular intervals;
the mounting holes are circumferentially formed on the second end portion at equal angular intervals;
the adjustment holes are circumferentially formed on the support at equal angular intervals.

6. The sight device as claimed in claim 5, wherein:
the positioning holes are threaded holes;
the mounting holes are through holes;
the adjustment holes are elongated slots;
the positioning adjustment elements are bolts.

7. The sight device as claimed in claim 2, wherein:
the mounting holes are threaded holes;
the adjustment holes are elongated blind holes;
the positioning adjustment elements are bolts.

8. The sight device as claimed in claim 1, further comprising:
an ocular lens unit disposed at the ocular lens end of the main lens barrel;
an aiming reticle element disposed in the first end portion and propped against an inner surface of a main body of the sight device;
wherein the ocular lens unit has a third focal length;
wherein a distance between an upright real image formed on the second image plane and the ocular lens unit is less than the third focal length;
wherein the aiming reticle element comprises an aiming reticle structure disposed on the first image plane;
wherein the optical axis is configured to pass through the aiming reticle element.

9. The sight device as claimed in claim 1, further comprising:
a display module comprising a display and a support;
wherein the support comprises an internal wall which defines an annular mounting groove;
wherein the display comprises an annular bracket and a display panel disposed on the annular bracket;
wherein the annular bracket engages with the annular mounting groove, so as to position the display panel on the support.

10. A sight device having an optical axis, comprising:
a main lens barrel comprising an objective lens end and an ocular lens end, wherein the optical axis is extended in an axial direction of the main lens barrel and passes through the main lens barrel;
an erector lens barrel comprising a first end portion and a second end portion disposed opposite to the first end portion, wherein the erector lens barrel is disposed in the main lens barrel, the first end portion comprises a first end surface, the second end portion comprises a second end surface, and the optical axis extended in the axial direction of the main lens barrel is configured to sequentially pass through the first end surface, the first end portion, the second end portion, and the second end surface;
an objective lens unit disposed in the main lens barrel and disposed at the objective lens end, wherein the optical axis is extended to pass through the objective lens unit and the objective lens unit has a first image plane disposed at the first end portion;
an erector unit disposed in the main lens barrel, wherein the optical axis is extended to pass through the erector unit and the erector unit has a second image plane;
wherein the first end surface has a first distance from the second end surface measured along the optical axis;
wherein the first end surface has a second distance from the second image plane measured along the optical axis;
wherein the first distance is less than the second distance and the first distance and the second distance have an interval therebetween.

11. The sight device as claimed in claim 10, further comprising:
a display module disposed at the second end portion;
wherein the display module comprises a display disposed on the second image plane, a support configured to carry the display, and a plurality of positioning adjustment elements;
wherein the second end portion defines a plurality of mounting holes;
wherein the support is disposed in the second end portion and defines a plurality of adjustment holes corresponding to the mounting holes;
wherein each of the positioning adjustment elements is passed through one mounting hole and the corresponding adjustment hole in a radial direction perpendicular to the optical axis so as to position the support;
wherein each of the adjustment holes is larger than each of the positioning adjustment elements in a direction of the optical axis so that a location of the support can be adjusted by moving the support along the optical axis until the display is located on the second image plane.

12. The sight device as claimed in claim 11, wherein:
the support is annular;
the display module further comprises a fixing ring disposed in the second end portion and propped against an internal wall of the support;
the fixing ring is an elastic ring with a deformable opening;
the support is movable with respect to the fixing ring;
the fixing ring defines a plurality of positioning holes corresponding to the mounting holes;
the positioning adjustment elements are connected to the positioning holes so that the support is held by an inner wall of the second end portion and an outer wall of the fixing ring.

13. The sight device as claimed in claim 10, further comprising:
a display module disposed at the second end portion;
wherein the display module comprises a display disposed on the second image plane, and a support configured to carry the display;
wherein the second end portion further comprises a curved flange;
wherein the sight device satisfies any of the following conditions:
0 mm<d≤16.5 mm,
0<d/(R1×2)≤0.55,
0<(L2−L1)/d≤0.45,
0.9≤|d−L3|/R1≤0.17,
where d is a dimension of the interval, R1 is a radius of the curved flange, L1 is a distance between the first image plane and the second image plane, L2 is a distance between the first end surface and the second end surface, and L3 is a dimension measured along the optical axis.

14. The sight device as claimed in claim 12, wherein:
the positioning holes are circumferentially formed on the fixing ring at equal angular intervals;
the mounting holes are circumferentially formed on the second end portion at equal angular intervals;
the adjustment holes are circumferentially formed on the support at equal angular intervals.

15. The sight device as claimed in claim 14, wherein:
the positioning holes are threaded holes;
the mounting holes are through holes;
the adjustment holes are elongated slots;
the positioning adjustment elements are bolts.

16. The sight device as claimed in claim 11, wherein:
the mounting holes are threaded holes;
the adjustment holes are elongated blind holes;
the positioning adjustment elements are bolts.

17. The sight device as claimed in claim 11, wherein each of the adjustment hole is larger than the positioning adjustment element in a circumferential direction of the support, such that the support can be rotated and adjusted in the circumferential direction.

18. The sight device as claimed in claim 12, wherein:
the second end portion further comprises a curved flange;
the mounting holes are formed on the curved flange;
the positioning adjustment elements are provided with the same or different radial engagement depth relative to the positioning holes, so that a radial position of the display on the second image plane can be adjusted, thereby calibrating and aligning the display with the upright real image.

19. The sight device as claimed in claim 10, further comprising:
an ocular lens unit disposed at the ocular lens end of the main lens barrel;
an aiming reticle element disposed in the first end portion and propped against an inner surface of a main body of the sight device;
wherein the ocular lens unit has a third focal length;
wherein a distance between an upright real image formed on the second image plane and the ocular lens unit is less than the third focal length;
wherein the aiming reticle element comprises an aiming reticle structure disposed on the first image plane;
wherein the optical axis is configured to pass through the aiming reticle element.

20. The sight device as claimed in claim 10, further comprising:
a display module comprising a display and a support;
wherein the support comprises an internal wall which defines an annular mounting groove;
wherein the display comprises an annular bracket and a display panel disposed on the annular bracket;
wherein the annular bracket engages with the annular mounting groove, so as to position the display panel on the support.
